(19) United States
(12) Patent Application Publication
(10) Pub. No.: US 2007/0073848 A1
(43) Pub. Date: Mar. 29, 2007

(54) Audio notification to aid email screening

(76) Inventor: Roger A. Fratti, Mohnton, PA (US)

Correspondence Address: MENDELSOHN & ASSOCIATES, P.C., 1500 JOHN F. KENNEDY BLVD., SUITE 405, PHILADELPHIA, PA, 19102, US

(21) Appl. No.: 11/237,994

(22) Filed: Sep. 28, 2005

(51) Int. Cl. G06F 15/177

(52) U.S. Cl. 709/220

(57) ABSTRACT

A communication method providing audio notification that can indicate to the recipient the relative importance of a particular email message. In one embodiment, a communication method of the invention enables the sender of an email message to provide for the message an audio tag that specifies a notification sound that can be produced at the recipient's email-enabled device, e.g., instead of a default notification sound. In another embodiment, the recipient's device is configured to produce a notification sound based on at least one of (i) priority level of the email message and (ii) the audio tag provided with the message. Embodiments of the invention enhance the recipient's ability to screen email messages without looking at the message content, which can advantageously reduce occurrences of unnecessary toggling between email and other user applications, thereby improving the recipient's productivity.

### BACKGROUND OF THE INVENTION

1. Field of the Invention

The present invention relates to communication systems and, more specifically, to email program products.

2. Description of the Related Art

Often, an office worker works at her desk or on a desktop computer with the email program minimized and running in the background or hidden by a screen saver. A typical email program, such as Microsoft Outlook, offers audio notification, which, when enabled, plays a particular sound upon arrival of a new email message. When the office worker hears a notification sound, she typically stops working on her current task and brings up the email program from the background to read the received email. She is often disappointed to find spam or junk email in her inbox, which was not worth the interruption.

### SUMMARY OF THE INVENTION

Problems in the prior art are addressed, in accordance with the principles of the present invention, by a communication method providing audio notification that can indicate to the recipient the relative importance of a particular email message. In one embodiment, a communication method of the invention enables the sender of an email message to provide for the message an audio tag that specifies a notification sound that can be produced at the recipient's email-enabled device, e.g., instead of a default notification sound. In another embodiment, the recipient's device is configured to produce a notification sound based on at least one of (i) priority level of the email message and (ii) the audio tag provided with the message. Embodiments of the invention enhance the recipient's ability to screen email messages without looking at the message content, which can advantageously reduce occurrences of unnecessary toggling between email and other user applications, thereby improving the recipient's productivity.

According to one embodiment, the present invention is a communication method comprising: (A) receiving an email message at an email-enabled device; and (B) configuring said device to produce a notification sound based on at least one of (i) priority level of the message and (ii) an audio tag provided with the message.

According to another embodiment, the present invention is a communication method, comprising: (A) providing an audio tag for an email message at a first email-enabled device; and (B) sending the message to a second email-enabled device, wherein said second device is configured to produce a notification sound based on at least one of (i) priority level of the message and (ii) said audio tag.

According to yet another embodiment, the present invention is an apparatus, comprising an email-enabled device adapted to receive an email message and produce a notification sound based on at least one of (i) priority level of the message and (ii) an audio tag provided with the message.

### BRIEF DESCRIPTION OF THE DRAWINGS

FIG. 1 shows a flowchart of a communication method according to one embodiment of the invention; and

FIG. 2 shows a flowchart of the processing that can be used to implement the step of configuring the recipient's computer to produce a notification sound in the method of FIG. 1 according to one embodiment of the invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

A typical prior-art email program, e.g., Microsoft Outlook and its add-ins, enables the recipient to assign unique notification sounds to different email senders/addresses. When the recipient hears a particular notification sound, she can sometimes recognize the source of the email message by the sound alone. She can then choose to read the message immediately or ignore it until she finishes her current task and/or has time to review the message. This feature can reduce unnecessary toggling between the email program and other desktop applications.

One problem with this prior-art audio notification scheme is that a relatively important email message requiring an urgent response might come from a source that is not assigned a unique notification sound. Typically, in this situation, the email program plays a default notification sound. Since the recipient would most likely associate the default sound with relatively unimportant email messages, she might decide to postpone reading this email message until a later time, thereby failing to produce an appropriate response. Another problem is that a source that is assigned a unique notification sound might send messages of varying importance and/or urgency. For example, in a company setting, a worker might presume that a message coming from the company's vice president is relatively important. She would likely interrupt her current task to read a message received from the vice-president only to find out that it was an announcement for a luncheon that would take place two weeks from now. Clearly, in this situation, the message was of relatively low importance and the interruption was largely unwarranted.

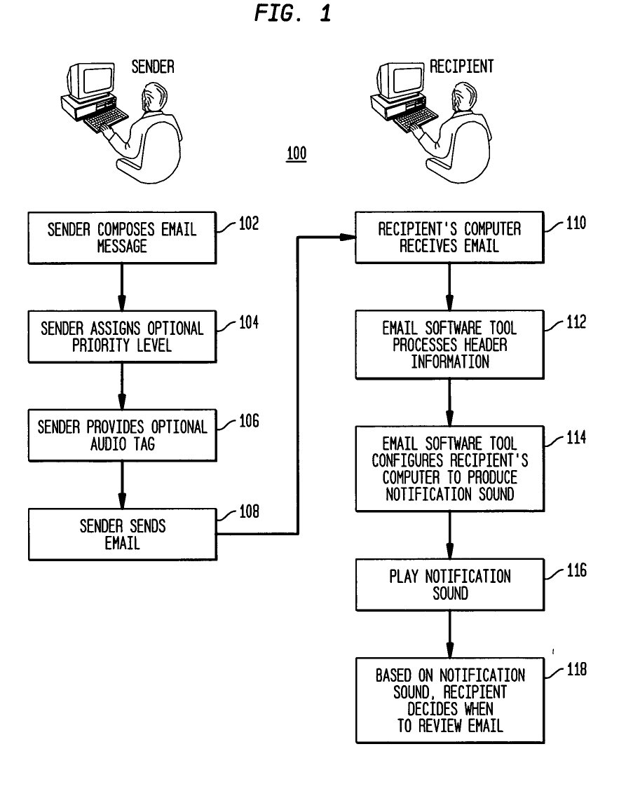

FIG. 1 shows a flowchart of a communication method 100 according to one embodiment of the invention. More specifically, method 100 provides a notification sound that can indicate to the recipient the relative importance of a particular email message. In addition, method 100 enables the sender to provide an audio tag specifying a sound that can be included into the notification sound for this email message. Method 100 enhances the recipient's ability to screen email messages without looking at the message content, which can advantageously decrease the number of unnecessary interruptions and, thus, improve the recipient's productivity.

At step 102 of method 100, the sender composes an email message. For example, the sender might type the text of the message and/or attach electronic files intended for the recipient. At step 104, the sender assigns an optional priority level to the message. For example, in Microsoft Outlook, there are three priority levels: high, normal, and low, with the normal priority level being a default priority level. The priority level typically does not affect the way email transport systems handle the message and is indicated by a small symbol in the email software tool, e.g., in the message toolbar and/or priority column in the message list. Usually, the default (normal) priority level is not indicated by any symbol and is used for messages that have no assigned priority. Other (e.g., high or low) priority levels have designated priority symbols associated with them such as, for example, an exclamation mark in Microsoft Outlook or a red double-caret in Eudora, for high priority messages. In one embodiment, the priority level is specified by a priority field in the message header.

At step 106 the sender optionally provides an audio tag to the email message. In one embodiment, the audio tag specifies a sound that can be included into the notification sound to be played by the recipient's computer upon receipt of this email message. In one configuration, the audio tag is an audio file that is incorporated into the message, e.g., in the message header. In another configuration, the audio tag is a filename that is specified in the message header and selected by the sender, e.g., from a (standard) audio-file library. At step 108, the sender sends the email message created in steps 102-106 to the recipient.

At step 110, the recipient's computer receives the email message from the sender. At step 112, the email software tool running on the recipient's computer processes the message header information. For example, the email software tool determines the message originator (e.g., the sender, the sender's email address, or the sender's domain) and priority level and reads the audio tag (if any). At step 114, the email software tool uses a local configuration file and the processed header information to configure the recipient's computer for producing a notification sound. In one embodiment, a notification sound is based on at least one of the message priority level and the audio tag provided by the sender. For example, in one configuration, a first specified tone or sequence of tones in the notification sound indicates high priority; a second specified tone or sequence of tones indicates normal priority; and a third specified tone or sequence of tones indicates low priority. These specified tones are played either alone or together with the sound indicating the message originator. The latter sound can contain at least one of: (i) the sound specified by the sender in the audio tag, (ii) a sound assigned by the recipient to this particular message originator, and (iii) a default notification sound.

At step 116, based on the configuration produced in step 114, the recipient's computer plays a corresponding notification sound. At step 118, based on the notification sound, the recipient then decides whether to interrupt the current task in order to review the received email message or postpone reviewing the message until a later, more-convenient time. Since, compared to prior-art email communication methods, method 100 provides a notification sound that can convey additional information to the recipient, method 100 helps the recipient to make better-informed decisions in the process of preliminary screening of received email messages. Advantageously, these better-informed decisions can help the recipient to reduce the number of unnecessary interruptions and, thus, improve the recipient's productivity in performing other tasks.

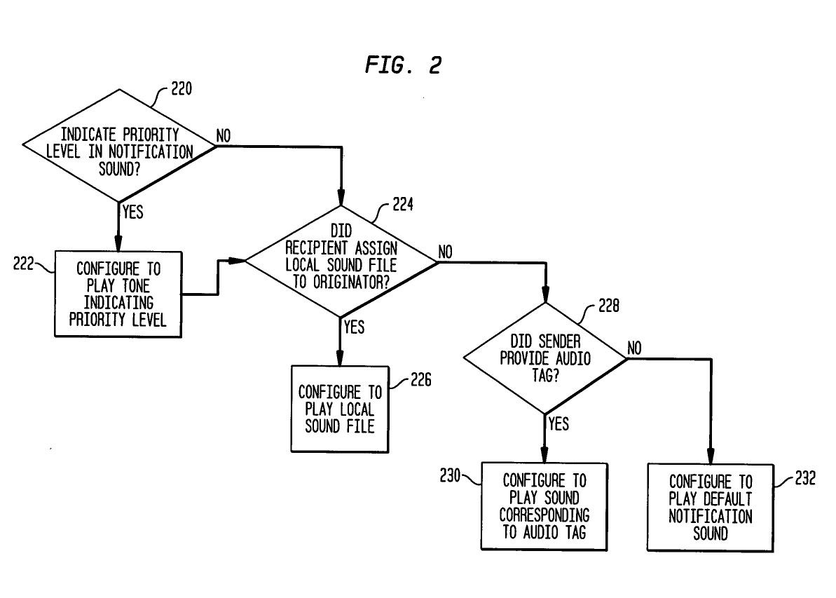

FIG. 2 shows a flowchart of the processing that can be used to implement step 114 of method 100 according to one embodiment of the invention. More specifically, at step 220, based on a local configuration file, the email software tool running on the recipient's computer determines whether the recipient prefers that a notification sound contain a tone or sequence of tones indicating the message priority level. If the answer is “yes,” then, at step 222, the email software tool configures the recipient's computer to play appropriate priority tone(s) corresponding to the message priority level indicated by the sender. If the answer is “no,” then the processing continues at step 224. The processing is also directed to step 224 after completion of step 222.

At step 224, based on the configuration file, the email software tool further determines whether the recipient has assigned a local audio file to the sender, sender's email address, or sender's domain. If the answer is “yes,” then, at step 226, the email software tool configures the recipient's computer to play the assigned audio file. If the answer is “no,” then the processing continues at step 228.

At step 228, the email software tool determines whether the sender provided an audio tag for this email message. If the answer is “yes,” then, at step 230, the email software tool configures the recipient's computer to play the sound corresponding to the audio tag. For example, when the audio tag is an audio file attached to the email message, the email software tool configures the recipient's computer to play that audio file. Alternatively, when the audio tag is a filename of an audio file from the audio-file library, the email software tool first retrieves that audio file from the library and then configures the recipient's computer to play that audio file. If the sender did not provide an audio tag, then the processing continues at step 232, where the email software tool configures the recipient's computer to play a default notification sound (if any).

After the execution of the processing of FIG. 2, the recipient's computer proceeds to step 116 (FIG. 1), where the computer uses the produced configuration to compose and play the corresponding notification sound. For example, depending on the configuration, the notification sound may contain: (1) the priority tone(s) and sound from the local audio file assigned to the sender by the recipient; (2) the priority tone(s) and sound corresponding to the audio tag; (3) priority tone(s) alone, e.g., when there is no local audio file assigned to the sender by the recipient, no audio tag provided by the sender, and no default notification sound; (4) sound corresponding to the audio tag alone; etc. Sounds can be played in any order. For example, for the second example above, the priority tone(s) can be played first and then immediately followed by the sound corresponding to the audio tag, or the sound corresponding to the audio tag can be played first and then immediately followed by the priority tone(s).

While this invention has been described with reference to illustrative embodiments, this description is not intended to be construed in a limiting sense. Although the invention has been described in reference to a computer configured to run email software, embodiments of the invention can also be practiced with other email-enabled devices, e.g., personal digital assistants (PDA's), cell phones, and internet appliances. Various tones and sounds, such as music, pure tones, combination tones, speech, and noise-like sounds, can be used to produce a notification sound without departing from the principles of the invention. Various modifications of the described embodiments, as well as other embodiments of the invention, which are apparent to persons skilled in the art to which the invention pertains are deemed to lie within the principle and scope of the invention as expressed in the following claims.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device adapted to practice the invention.

What is claimed is:

1. A communication method, comprising:
(A) receiving an email message at an email-enabled device; and
(B) configuring said device to produce a notification sound based on at least one of (i) priority level of the message and (ii) an audio tag provided with the message.

2. The invention of claim 1, wherein, for each priority level, the notification sound comprises a specified tone or sequence of tones corresponding to the priority level.

3. The invention of claim 2, wherein the notification sound consists essentially of the specified tone or sequence of tones corresponding to the priority level.

4. The invention of claim 2, wherein the notification sound further comprises a sound corresponding to the audio tag.

5. The invention of claim 1, wherein the notification sound comprises a sound corresponding to the audio tag.

6. The invention of claim 1, wherein the audio tag comprises an audio file attached to the message.

7. The invention of claim 1, wherein:
the audio tag comprises a filename of a file from a file library; and
step (B) comprises retrieving from the file library the file having said filename.

8. The invention of claim 1, wherein step (B) comprises:
determining user preference with respect to indicating the priority level in the notification sound; and
if the user preference is to indicate the priority level in the notification sound, then configuring said device to produce the notification sound based on the priority level.

9. The invention of claim 8, wherein step (B) further comprises:
determining whether there is an assigned sound corresponding to the message originator; and
if there is the assigned sound, then configuring said device to include the assigned sound into the notification sound.

10. The invention of claim 9, wherein step (B) further comprises:
if there is no assigned sound, then determining whether the message has the audio tag; and
if the message has the audio tag, then configuring said device to include a sound corresponding to the audio tag into the notification sound.

11. A machine-readable medium on which is stored instructions for programming said device to execute the method of claim 1.

12. An apparatus configured to execute the method of claim 1.

13. A communication method, comprising:
(A) providing an audio tag for an email message at a first email-enabled device; and
(B) sending the message to a second email-enabled device, wherein said second device is configured to produce a notification sound based on at least one of (i) priority level of the message and (ii) said audio tag.

14. The invention of claim 13, wherein the audio tag comprises an audio file attached to the message.

15. The invention of claim 13, wherein:
the audio tag comprises a filename of a file from a file library; and
the second device is configured to retrieve from the file library the file having said filename.

16. A machine-readable medium on which is stored instructions for programming the first device to execute the method of claim 13.

17. An apparatus configured to execute the method of claim 13.

18. An apparatus, comprising an email-enabled device adapted to receive an email message and produce a notification sound based on at least one of (i) priority level of the message and (ii) an audio tag provided with the message.

19. The invention of claim 18, wherein the notification sound comprises a sound corresponding to the audio tag, wherein the audio tag comprises at least one of (a) an audio file attached to the message and (b) a filename of a file from a file library, wherein the device is adapted to retrieve from the file library the file having said filename.

20. The invention of claim 18, wherein the device is adapted to:
determine user preference with respect to indicating the priority level in the notification sound; and
determine whether there is an assigned sound corresponding to the message originator, wherein:
if the user preference is to indicate the priority level in the notification sound, then said device is configured to produce the notification sound based on the priority level;
if there is the assigned sound, then said device is configured to include the assigned sound into the notification sound;
if there is no assigned sound, then said device is configured to determine whether the message has the audio tag; and
if the message has the audio tag, then said device is configured to include a sound corresponding to the audio tag into the notification sound.
